(19) United States
(12) Patent Application Publication
(10) Pub. No.: US 2010/0024661 A1
(43) Pub. Date: Feb. 4, 2010

(54) Barbecue rack

(76) Inventor: Bor-Yih Wu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/219,970

(22) Filed: Jul. 31, 2008

(51) Int. Cl. A47J 37/07

(52) U.S. Cl. 99/339

(57) ABSTRACT

A barbecue rack includes a rack body, a swivel seat and a rotating unit. The rack body has a disc therein. The disc has a first gear section. The motor has a shaft penetrating through the disc and secured with the swivel seat. The swivel seat comprises a locating block to accommodate the rotating unit. The rotating unit has a first insertion hole at a front end for a skewer to seat thereon. The rotating unit has a second gear section around the edge of the rotating unit to be meshed with the first gear section. When the motor is activated, the rotating unit will be linked to spin on the locating block so as to roast the food evenly.

### BACKGROUND OF THE INVENTION

1. Field of the Invention

The present invention relates to a barbecue rack, and more particularly to one having a motor to link a disc to rotate which in turn links a rotating unit to spin so as to roast food evenly.

2. Description of the Prior Art

A conventional barbecue rack is to place food on a metal net and seating on top of the rack with fire underneath to roast the food. This design requires the user to turn the food every once in a while in order to roast both sides of the food and also to prevent the food from being overcooked. This requires a person to stand by, or someone needs to pay an extra attention on the food. The other disadvantage is that the food may be cooked unevenly if it is handled by someone who is not familiar with cooking.

### SUMMARY OF THE INVENTION

In view of these and many other shortcomings, the present invention provides a barbecue rack comprising a rack body having a disc therein, the disc having a first gear section thereon, the rack body having a bottom provided with a motor, the motor having a shaft penetrating through the disc, the shaft being provided with a fastener; a swivel seat connected to the shaft of the motor, the swivel seat comprising a locating block thereon, the locating block being formed with a recess; and a rotating unit disposed on the locating block of the swivel seat, the rotating unit comprising a second gear section meshing with the first gear section of the disc, the rotating unit having a first insertion hole at a front end thereof and a locating section at a rear end thereof.

The rack body comprises a chamber therein, the bottom of the rack body being formed with a water hole plugged with a plug.

The rack body comprises a number of nets therein, each net comprising supporting legs extending downwardly therefrom.

The rack body comprises a linking rod pivotally connected to the bottom of the rack body, one end of the linking being connected with a supporting rod.

The rack body is provided with a cover, the cover having a first through hole at a central portion thereof and a clip corresponding in position to the first through hole of the cover to hold an extension rod thereat, the extension rod fitting onto the shaft.

The swivel seat comprises a connecting rod extending outwardly from the swivel seat, the connecting rod comprising a pair of connecting ends extending from one end at respective sides.

The swivel seat has a second through hole at a central portion thereof for insertion of the shaft.

The swivel seat is formed with a slot for insertion of the locating block.

The first insertion hole has a square shape.

The rotating unit has a second insertion hole at the front end thereof.

A tabletop is provided on the linking rod.

It is the primary object of the present invention to provide a barbecue rack, which provides a rotating unit enabling to rotate with respect to a disc that links a skewer seating on top of a fire to spin to ensure the food can be roasted evenly.

It is another object of the present invention to provide a barbecue rack, which provides a chamber in the rack body to be poured with water therein and a net for placing charcoal located in the chamber, which has a good circulation and the water to collect residue from the food and charcoal.

It is a further object of the present invention to provide a barbecue rack, which provides a cover to keep the food from contamination and to keep the food warm.

It is still a further object of the present invention to provide a barbecue rack, which can be collapsed for storage.

### BRIEF DESCRIPTION OF THE DRAWINGS

FIG. 1 is a perspective view of a preferred embodiment of the present invention;

FIG. 2 is a cross-sectional view of the preferred embodiment of the present invention;

FIG. 3 is a partially exploded view of the preferred embodiment of the invention;

FIG. 4 is a cross-sectional view of the preferred embodiment of the present invention showing the assembly of a swivel seat and a rotating unit;

FIG. 5 is a top view of the preferred embodiment of the present invention showing the swivel seat and the rotating unit; and

FIG. 6 is a perspective view showing food roasted on a barbecue rack according to the present invention.

### DETAILED DESCRIPTION OF THE PREFERRED EMBODIMENT

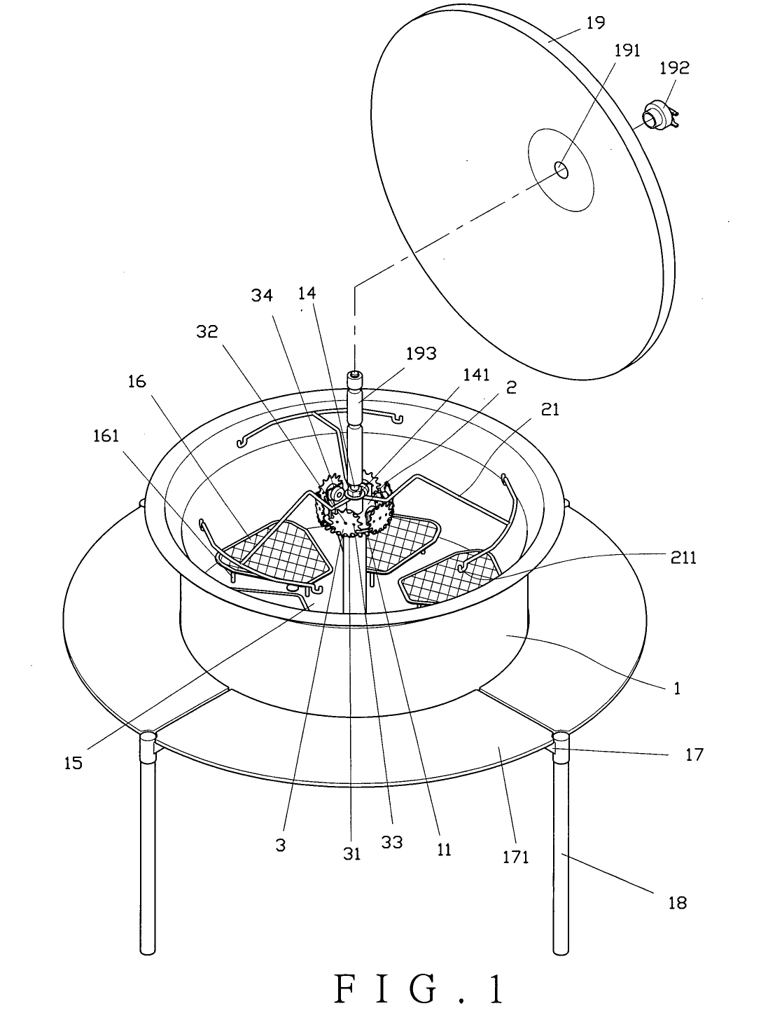

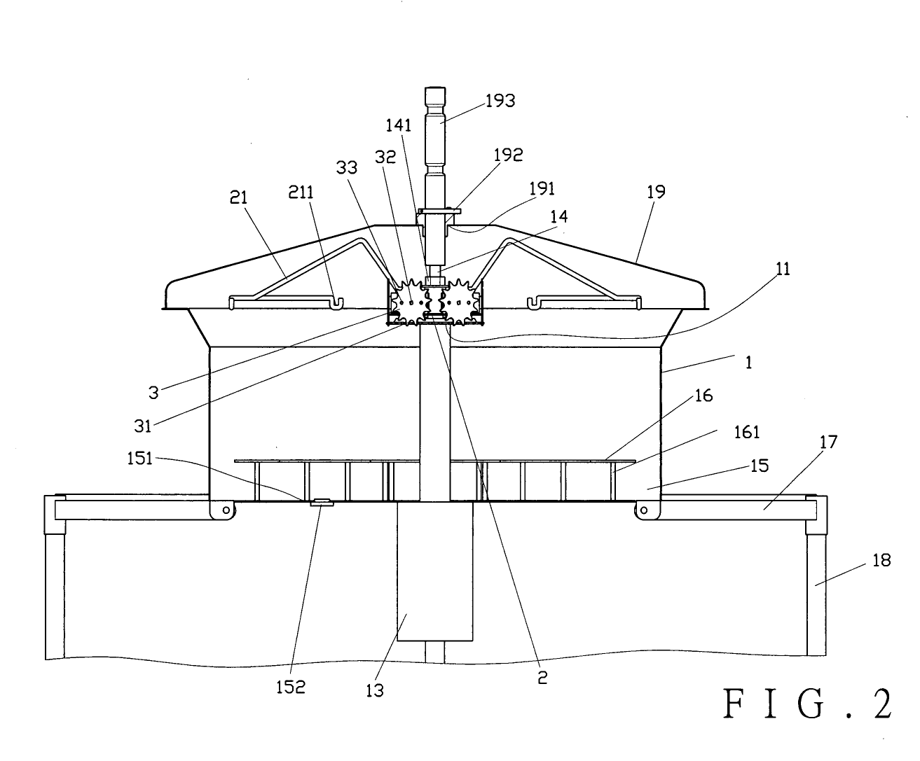

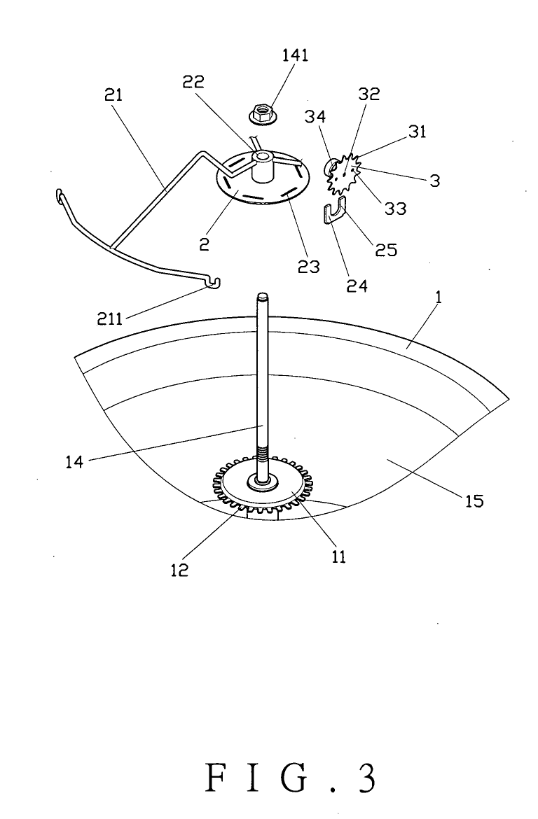

As shown in FIGS. 1, 2, and 3, a preferred embodiment of the present invention comprises a rack body 1, a swivel seat 2, and a number of rotating units 3.

The rack body 1 comprises a disc 11 protruding inwardly. The disc 11 is formed with a first gear section 12 around the edge of the disc 11. A motor 13 is outwardly disposed at the bottom of the rack body 1. The motor 13 is powered by outside resource, and comprises a shaft 14 penetrating through the disc 11. A fastener 141 is provided on the shaft 14. The rack body 1 has a chamber 15 therein. The bottom of the rack body 1 is formed with a water hole 151. The water hole 151 is plugged with a plug 152. A number of fan-shaped nets 16 are provided in the chamber 15. Each net 16 is provided with supporting legs 161. A number of linking rods 17 are pivotally connected to the bottom of the rack body 1. One end of each linking rod 17 is connected with a supporting rod 18. A tabletop 171 is provided on the linking rods 17. A cover 19 is provided on the rack body 1. The cover 19 has a first through hole 191 at a central portion thereof. The cover 19 is provided with a clip 192 corresponding in position to the first through hole 191 to hold an extension rod 193 thereat. The extension rod 193 is inserted through the first through hole 192 and fits onto the shaft 14. The cover 19 is adjustable with respect to the extension rod 193 by the clip 192.

The swivel seat 2 is connected to the shaft 14 of the motor 13, and comprises a number of connecting rods 21 extending outwardly therefrom. Each connecting rod 21 comprises a pair of connecting ends 211 extending from one end at respective sides. The swivel seat 2 is formed with a second through hole 22 at a central portion thereof and a number of slots 23 around a circumferential portion of the swivel seat 2. Each slot 23 is adapted for insertion of a locating block 24. The locating block 24 is formed with a U-shaped recess 25.

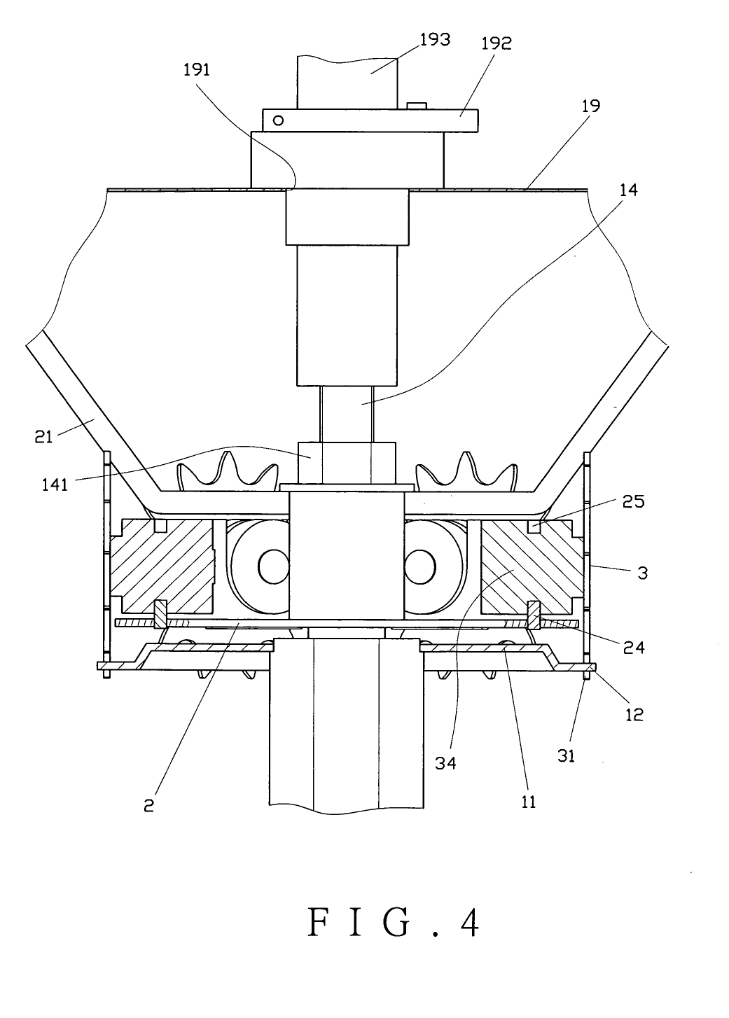

Each rotating unit 3 is disposed on the locating block 24 of the swivel seat 2. The rotating unit 3 is designed like a gear and has a second gear section 31 to be meshed with the first gear section 12 of the disc 11, as shown in FIG. 4. The rotating unit 3 has a square first insertion hole 32 at a front central portion thereof, a pair of second insertion holes 33 at respective sides of the first insertion hole 32, and a locating section 34 at a rear end of the rotating unit 3.

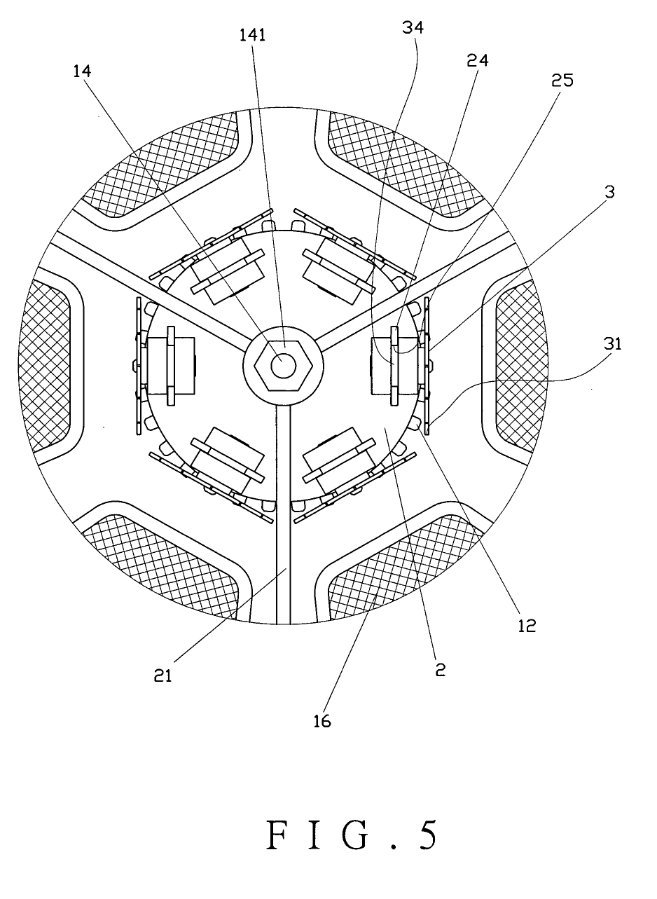

To assemble the present invention, as shown in FIGS. 1, 2, 4 and 5, the swivel seat 2 is placed on the disc 11 of the rack body 1, with the shaft 14 of the motor 13 penetrating through the second through hole 22. The fastener 141 is to secure the swivel seat 2 on the shaft 14. The locating block 24 is inserted into the slot 23. The locating section 34 of each rotating unit 3 is placed into the recess 25 of the locating block 24. The second gear section 31 of the rotating unit 3 meshes with the first gear section 12 of the disc 11 so that each rotating unit 3 is linked to spin by the disc 11. The nets 16 are placed in the chamber 15 of the rack body 1. The extension rod 193 is inserted through the first through hole 191 and fits onto the shaft 14. The clip 192 clips the extension rod 193 at a proper position to adjust the cover 19 along the extension rod 193 to check the food in the rack body 1 or to cover the rack body 1 to keep the food warm.

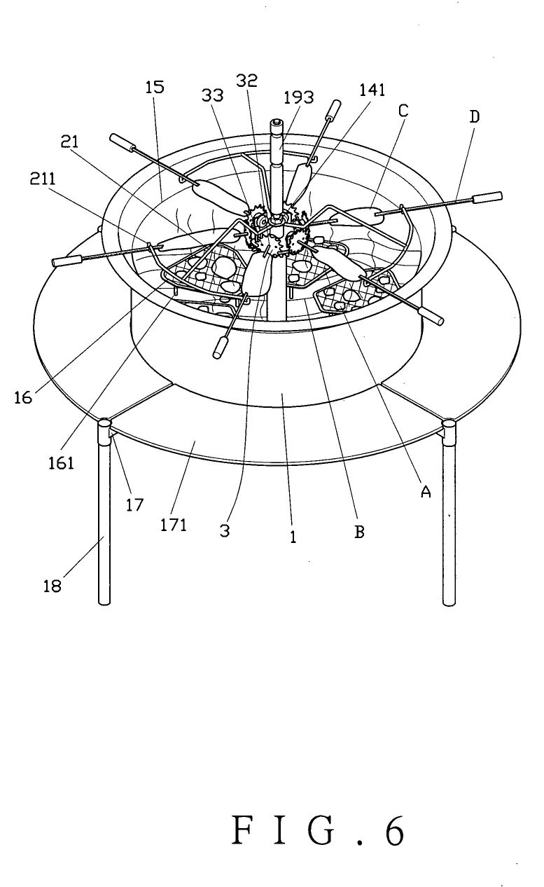

To operate the present invention, as shown in FIGS. 4, 5, and 6, charcoal A is placed on top of each net 16 in the chamber 15. The chamber 15 is poured with water, and the charcoal A is lighted up. The ashes from burning the charcoal 15 and oil dripping from food will be collected by the water in the chamber 15. One end of a skewer D with food C is inserted into the first insertion hole 32 of the rotating unit 3. If the skewer D is in Y-like shape, the skewer D is inserted into the second insertion holes 33. The other end of the skewer D is placed on the connecting end 211 of the connecting rod 21. When the motor 13 is activated, the shaft 14 will link the swivel seat 2 and the disc 11 to rotate. The first gear section 12 of the disc engages with the second gear section 31 of the rotating unit 3 to link the rotating unit 3 to spin. The rotation of the rotating unit 3 links the skewer D to spin, thus the food C on the skewer D to be roasted evenly.

What is claimed is:

1. A barbecue rack, comprising:
a rack body comprising a disc therein, said disc having a first gear section thereon, said rack body having a bottom provided with a motor, said motor having a shaft penetrating through said disc, said shaft being provided with a fastener;
a swivel seat connected to said shaft of said motor, said swivel seat comprising a locating block thereon, said locating block being formed with a recess; and
a rotating unit disposed on said locating block of said swivel seat, said rotating unit comprising a second gear section meshing with said first gear section of said disc, said rotating unit having a first insertion hole at a front end thereof and a locating section at a rear end thereof.

2. The barbecue rack, as recited in claim 1, wherein said rack body comprises a chamber therein, the bottom of said rack body being formed with a water hole plugged with a plug.

3. The barbecue rack, as recited in claim 1, wherein said rack body comprises a number of nets therein, each said net comprising supporting legs extending downwardly therefrom.

4. The barbecue rack, as recited in claim 1, wherein said rack body comprises a linking rod pivotally connected to the bottom of said rack body, one end of said linking being connected with a supporting rod.

5. The barbecue rack, as recited in claim 1, wherein said rack body is provided with a cover, said cover having a first through hole at a central portion thereof and a clip corresponding in position to said first through hole of said cover to hold an extension rod thereat, said extension rod fitting onto said shaft.

6. The barbecue rack, as recited in claim 1, wherein said swivel seat comprises a connecting rod extending outwardly from said swivel seat, said connecting rod comprising a pair of connecting ends extending from one end at respective sides.

7. The barbecue rack, as recited in claim 1, wherein said swivel seat has a second through hole at a central portion thereof for insertion of said shaft.

8. The barbecue rack, as recited in claim 1, wherein said swivel seat is formed with a slot for insertion of said locating block.

9. The barbecue rack, as recited in claim 1, wherein said first insertion hole has a square shape.

10. The barbecue rack, as recited in claim 1, wherein said rotating unit has a second insertion hole at the front end thereof.

11. The barbecue rack, as recited in claim 1, wherein a tabletop is provided on said linking rod.
